(19) United States
(12) Patent Application Publication
(10) Pub. No.: US 2014/0184075 A1
(43) Pub. Date: Jul. 3, 2014

(54) OUTDOOR LED LAMP WITH HEATED COVER

(71) Applicant: The Artak Ter-Hovhanissian Patent Trust, Woodland Hills, CA (US)

(72) Inventor: Artak Ter-Hovhannissian, Glendale, CA (US)

(73) Assignee: The Artak Ter-Hovhanissian Patent Trust, Woodland Hills, CA (US)

(21) Appl. No.: 14/196,820

(22) Filed: Mar. 4, 2014

Related U.S. Application Data
(63) Continuation-in-part of application No. 12/490,230, filed on Jun. 23, 2009, now Pat. No. 8,661,660.

(51) Int. Cl. F21V 29/00

(52) U.S. Cl. CPC F21V 29/008
USPC 315/114

(57) ABSTRACT

An outdoor LED lamp assembly includes a light transmissive cover disposed over at least one LED chip of the lamp assembly. A heating element is provided for providing heat to the cover. A sensor may be used to detect cover conditions, such as the accumulation of condensation, ice or snow on the cover, so as to provide electricity to the heating element and heat the cover in order to remove the condensation, ice or snow on the cover.

### BACKGROUND OF THE INVENTION

The present invention generally relates to light emitting diode (LED) lamp assemblies. More particularly, the present invention relates to an outdoor LED lamp assembly having a heated cover.

Light emitting diodes (LEDs) have been available since the early 1960s in various forms. LEDs have demonstrated advantages of small size, low power consumption, long life, and endurance of vibration. As such, LEDs are now widely applied in a variety of ways, including signs and message boards, vehicle lights, outdoor lamps, including parking lot and street lamps and vehicle control lamps and the like.

The relatively high efficiency of LEDs is the primary reason for their popularity. Tremendous power savings are possible when LEDs are used to replace traditional incandescent lamps of similar luminous output. In comparison with incandescent lamps, LEDs can reduce power consumption by more than forty percent. Thus, LEDs are being introduced in various illumination fields as part of power-saving plans in virtually every country.

There are hundreds of millions of street lights in the world. They are an integral part of the city architecture and necessary to keep the streets lit at night. Currently, the majority of street lights are made with high-intensity discharge (HID) lamps, such as high pressure sodium or metal halide lamps, which include a ballast, metal housing and glass cover. The HID and sodium lamps generate a lot of heat when operating, therefore a glass cover instead of a plastic cover is used to cover the lamp. Due to the heat generated by the HID lamps, the glass cover gets quite hot due to the operation of the lamp.

With the increasing usage of LED lamps, LED-based street lights have been used. However, in cold temperatures, such as when it snows and there are blizzards, the lamps get covered with condensation, snow and even ice, blocking the emitted light. With standard gas-filled lamps and HID lamps, condensation, ice and snow quickly clears up as the lamps get warm very quickly as they are turned on and the ice and snow melts and the condensation is evaporated. However, with LED lamps, the lamp does not generate enough heat to solve this problem, therefore the emission of light is blocked. Tests have shown that up to ninety-five percent of the light emitted from the LED street light can be blocked from snow and ice covering the glass or plastic cover. The snow and ice buildup also damages the electronics in the electronic driver or power supply, since the power supply contains wet chemicals inside the electrolytic capacitors that freeze and expand, causing it to fail prematurely.

Similar problems exist with LED traffic lights in places where it is cold and snows. The traffic light cover does not get warm enough, and the lamp cover is prone to condensation, freezing, snow and ice accumulation. This creates a very dangerous situation where deadly accidents can occur if the traffic light is not visible. In fact, at least one deadly accident has occurred where a car passed a red light which was covered with ice and was not visible to the driver. Due to this incident, many cities have replaced the LED traffic lights with the conventional traffic lights with bulbs, even though they are not as long lasting or power efficient.

Street lamps and traffic control lights are just two examples of the many different types of outdoor lamps where LEDs can be used, with their attendant benefits, although in cold weather climates condensation, ice and snow accumulation can restrict their use and efficacy.

Accordingly, there is a continuing need for an outdoor lamp assembly which incorporates LEDs so as to take advantage of their low power consumption, high power efficiency, longevity, resistance to vibration etc., while overcoming the problems relating to the buildup of condensation, snow and ice on the covers of such outdoor LED lamps. The present invention fulfills these needs, and provides other related advantages.

### SUMMARY OF THE INVENTION

The present invention resides in an outdoor LED lamp assembly wherein the cover is heated so as to remove the buildup of condensation, snow and ice which would otherwise degrade the light transmittance of such lamp assemblies.

The outdoor LED lamp of the present invention generally comprises a base, at least one LED chip positioned on the base, and a light transmissive cover disposed over the at least one LED chip. A heating element is provided to heat the cover.

The heating element may comprise a coating disposed on at least a portion of the surface cover. The heating element may comprise one or more resistance heating elements, such as an electrically conductive wire with sufficient resistance to impart heat to the cover. The one or more resistance heating elements may be disposed on or adjacent to a peripheral edge of the cover. The LED lamp may include a sensor for detecting cover conditions, such as water condensation or the accumulation of ice or snow on the cover. An electronic circuit provides electricity to the heating element to provide heat to the cover when the predetermined cover conditions are sensed by the sensor.

Various types of sensors are contemplated by the invention. For example, the sensor may comprise a photosensor. Alternatively, the sensor may comprise spaced apart conductive traces disposed on the cover which provide an electrical signal when condensation or ice or snow extends across adjacent conductive traces.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a cross-sectional view of an outdoor LED lamp assembly embodying the present invention, and having a cover thereof exploded from a base and housing of the assembly;

FIG. 2 is a top plan view of a base of the assembly, having a plurality of LED chips thereon as well as a sensor and electronic circuit, used in accordance with the present invention;

FIG. 3 is a top plan view of a cover having a heating element extending around a peripheral edge thereof, in accordance with the invention;

FIG. 4 is a diagrammatic view illustrating a heating element of the cover connected to a power source, in accordance with the present invention;

FIG. 5 is a cross-sectional view illustrating the application of heat to the cover of the lamp assembly;

FIG. 6 is a cross-sectional view similar to FIG. 1, but incorporating a different type of heating element;

FIG. 7 is a top plan view of the cover and heating element which can be used in the LED lamp assembly of FIG. 6; and

FIG. 8 is a diagrammatic view illustrating an arrangement to sense the presence of condensation, snow or ice, in accordance with the present invention.

### DEATAILED DESCRIPTION OF THE PREFERRED EMBODIMENTS

As shown in the accompanying drawings, for purposes of illustration, the present invention is related to an outdoor LED lamp assembly having a heated cover. The ability to heat the cover of the lamp assembly enables the lamp assembly to remove accumulated condensation, snow and built-up ice on the cover and thus light from the LEDs to be transmitted through the cover. In this manner, LED lamp assemblies can be used outdoors, even in cold climates where snow and freezing temperatures otherwise can cause accumulated ice, snow, condensation and the like on the cover and render the outdoor LED lamp assembly inefficient at best and inoperable or unuseful at worst.

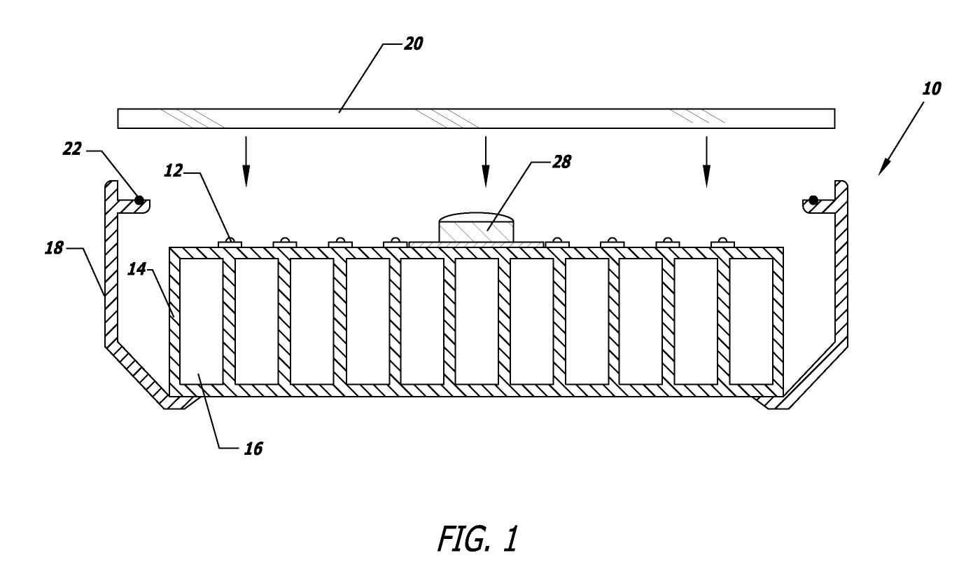

With reference now to FIG. 1, an LED lamp assembly 10 embodying the present invention is shown in cross-section. The assembly 10 includes at least one light emitting diode (LED) chip 12. Typically, a plurality of LEDs will be formed in an array, the number of LEDs and the configuration of the array varying depending upon the application of the outdoor LED lamp assembly 10. For example, in a street lamp application the LEDs 12 may be formed in a generally rectangular array. However, in a traffic control light assembly the LEDs may be formed in a generally circular array. The LEDs 12 can emit white light, or can be selected so as to emit yellow, red, green, etc. light, depending upon the application.

The LEDs 12 are operably placed on a base 14. The base may comprise a printed circuit board (PCB) with electrical traces interconnecting the LEDs with additional circuitry and a power source, as is well known in the art. The power source may be a direct current power source, or a converter which converts alternating current to a direct current which can be used by the LEDs 12.

The base 14 may comprise an electrically and thermally conductive base. For example, the base 14 may be that such as described in U.S. Pat. No. 7,676,915 B2 and U.S. Publication No. 2010/0240158 A1, the contents of which are incorporated herein by reference. As such, the base 14 would include a very thin electrically insulating coating on at least a portion of the surface thereof. The base would be comprised of a metal material with at least a top surface thereof anodized. For example, the base 14 could be comprised of aluminum or an aluminum alloy. Aluminum is a superb thermal conductor, being ninety percent more thermally conductive than traditional PCB, and costing eighty percent less to produce than other metal core PCBs. By anodizing the aluminum, a very thin layer of the surface becomes a dielectric in the form of an aluminum oxide film. The aluminum oxide film could be as thin as three microns. Such anodized coating is extremely adherent and offers excellent thermal conductance and acceptable puncture voltage so as to serve as an electrically insulating coating to the underlying aluminum or aluminum alloy material, which is electrically conductive. The circuit traces (not shown) could be formed on the anodized surface or portions of the base 14. Such circuit traces would be disposed in predetermined spaced lengths along predetermined routes to provide electrical conduction between traces while interconnecting the various electrical components used in powering and operating the LEDs. Such circuit traces could be printed, plated, anodized, etc., as is well known in the art. The circuit traces are electrically and thermally conductive.

As is known in the art, the LED chips 12 generate heat at the base thereof, which must be removed from the LED in order to prevent its overheating and destruction. A thermally conductive base, such as one comprised of aluminum or an aluminum alloy, could serve to remove such heat from the LED chips. As such, the base 14 would act as a heat sink. The base 14 may include heat dissipating passageways 16, grooves, fins, etc. formed or otherwise attached to the base 14 to facilitate heat dissipation from the LED chips 12.

The assembly 10 typically includes a housing 18 which at least partially surrounds the base 14 for protection and mounting purposes. The housing 18 may be comprised of a thermally conductive material, such as metal, or a non-thermally conductive material such as a plastic material. In the event that the housing 18 is comprised of a metal or other thermally conductive material, the heat from the LEDs 12 could be transferred from the base 14 to the housing 18 for further heat dissipation.

With continued reference to FIG. 1, a cover 20 is disposed over the LEDs 12. Typically, the cover 20 is attached to the housing 18 so as to be disposed over the LED array. The cover 20 may be comprised of any appropriate light transmissive material. As such, the cover 20 can be comprised of glass or plastic materials. In the context of the present invention, the material used for the cover 20 should be capable of being heated so as to remove the condensation, snow, and ice accumulation on an outer surface thereof during certain weather conditions. As such, glass or a glass-based material is a preferred material for the cover 20 of the lamp assembly 10 of the present invention as glass is capable of being heated and cooled repeatedly without adverse consequences. Of course, various types of plastics or combinations of materials or heat-treated materials which are light transmissive could also be used.

It will be understood by those skilled in the art that the cover 20 can be clear or colored. For example, the cover 20 may be of a green color, red color, or yellow color so as to transmit green, red or yellow light from the white LEDs 12 disposed in relation thereto so as to emit green, yellow, and red light, such as in the case of a traffic control lamp assembly. Alternatively, as discussed above, the LEDs 12 could emit green, yellow and red light and the cover 20 could be clear. Of course, the cover 20 could be clear and the LEDs 12 emit white light in the case where colored light is not needed, such as a street or parking lot lamp assembly.

With reference now to FIGS. 1, 3 and 4, a heating element 22 is used to provide heat to the cover 20. As such, the heating element 22 is thermally conductive, or is of a resistance heating element type such that it has sufficient conductive resistance to heat upon the application of electricity and thus transfer the heat to the cover 20.

It is contemplated by the present invention that the heating element 22 could be thermally conductive so as to transfer the heat generated from the LEDs 12 through the base 14 and housing 18 directly to the cover 20. However, in most instances of the present invention, the heating element 22 will have electricity supplied thereto so as to heat the heating element 22, and transfer the heat to the cover 20 in order to heat the cover 20 sufficiently so as to remove the accumulated condensation, snow or ice.

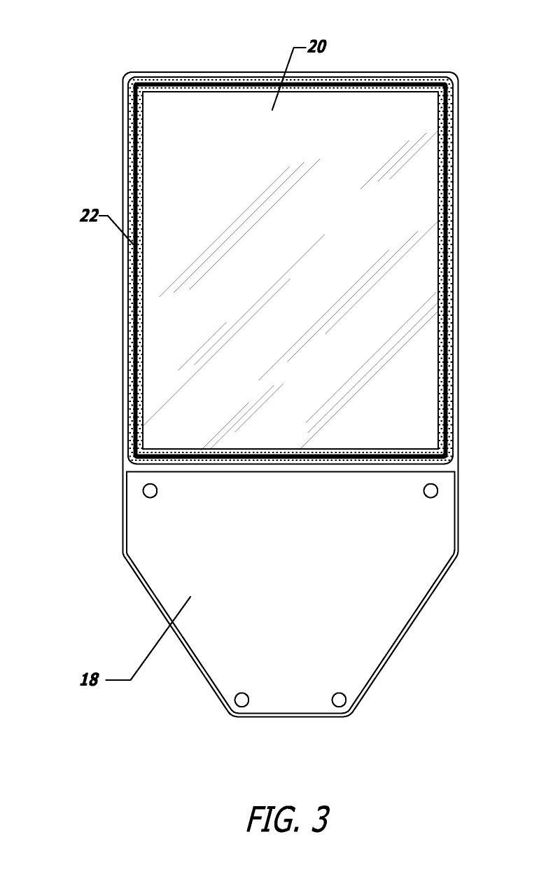

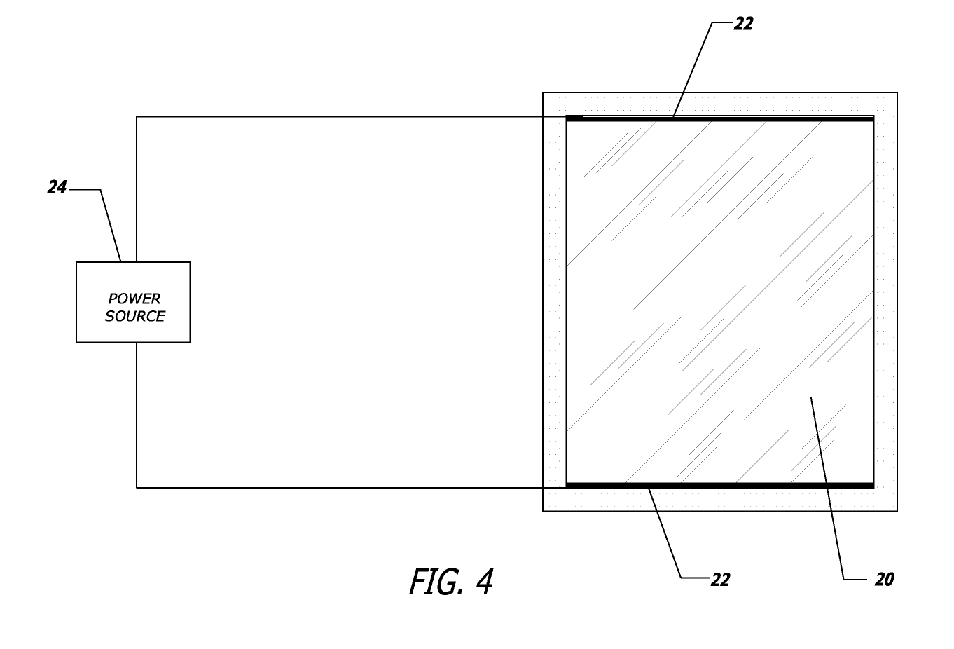

As illustrated in FIG. 3, in one embodiment, the heating element 22 is positioned generally around a peripheral edge of the cover 20. In FIG. 4, the heating element 22 comprises bus bars, or strips of conductive material, such as silver or copper strips, which are connected to a power source 24. The bus strips or peripheral wire 22 may be disposed directly onto the cover 20 or onto a portion of the housing 18, as illustrated in FIG. 1, so as to contact the cover 20 when the cover 20 is attached to the housing 18. The important aspect is that the heating element 22 is able to transfer heat to the cover 20 and heat the cover 20 to a sufficient temperature to remove the accumulated condensation, snow or ice.

The power source 24 could be the same power supply as the LED driver, which powers the LEDs, a dedicated power supply, or the power source could come directly from AC power, such as that supplied to the street lamp, traffic control light, etc. The power source 24 could include the necessary electrical components such as power transformers, inverters, etc. so as to supply the heating element 22 with direct current, alternating current, the correct voltage and/or current as necessary in order to operate the heating element 22.

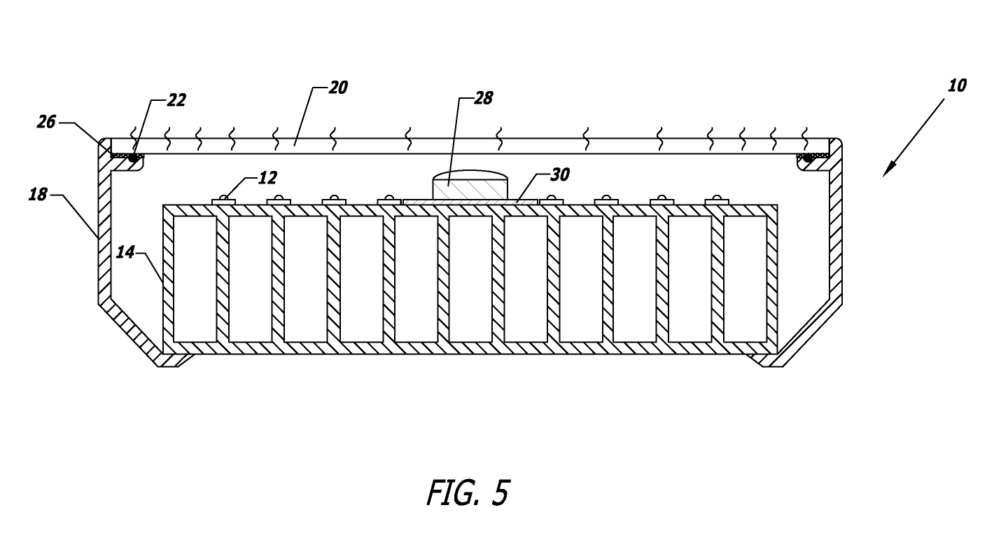

With reference now to FIG. 5, an assembled lamp assembly 10 is shown, with power being supplied to the heating element 22 and the cover 20 being attached to the housing 18 and in operable contact or relation with the heating element 22, such as the use of an adhesive 26, which may be thermally conductive, in order to impart heat (shown by the non-linear lines emanating from the cover) to the cover 20.

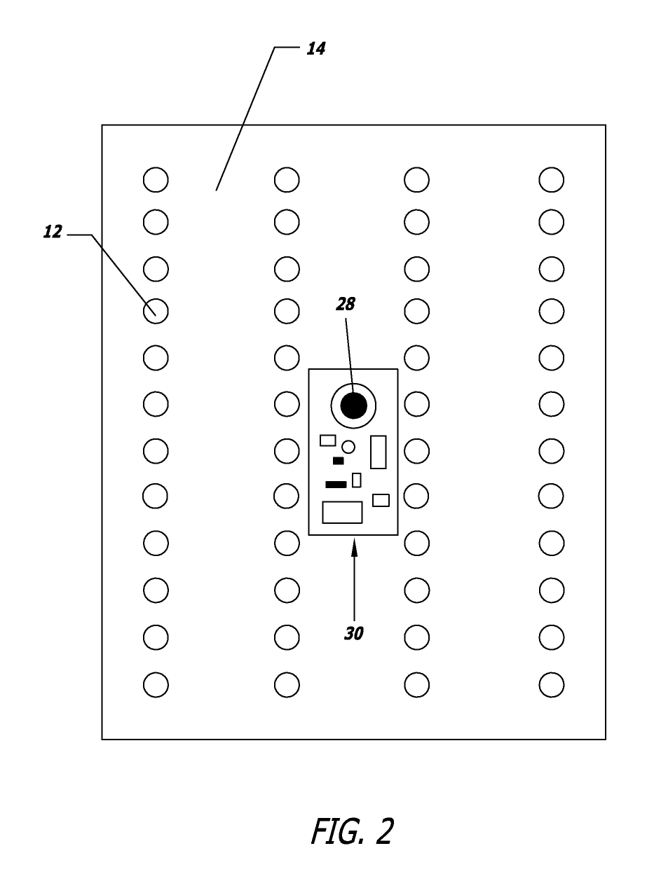

With reference again to FIGS. 1 and 2, heat could be supplied to the cover 20 constantly, either by means of directing the heat generated from the base of the LEDs 12 through a heat sink to the cover 20, which also serves as part of the heat sink, or more typically by directly applying electricity to the heating element 22 so as to heat the heating element 22 and thus the cover 20. However, in a particularly preferred embodiment heat is only supplied to the cover 20 when the presence of condensation and accumulated snow and/or ice is detected. In such cases, the present invention will utilize smart circuitry to heat the cover 20 automatically when accumulated condensation, snow and/or ice is detected. The lamp assembly 10 of the present invention incorporates an automated detection system to detect the condensation, snow and ice buildup and then activate the heating element 22 to heat the cover 20 until the condensation, snow and ice is removed after which the assembly 10 will cease supplying power to the heating element 22.

As shown in FIG. 1, a sensor 28, such as a photocell, may be used to detect the presence of accumulated condensation, snow and ice. When condensation, snow and ice is not present, light from the photosensor 28 will be transmitted through the cover 20. However, when sufficient condensation, snow and ice accumulates to a certain level, the light from the photosensor will be reflected back into the sensor 28, which will activate an electronic circuit 30 to supply power to the heating element 22 through the power source 24. Although the heating element may be activated for a predetermined period of time, more typically the sensor, such as the photocell 28, is used to indicate to the circuitry when the condensation, snow and ice has been removed due to melting and evaporation by the heating of the cover 20. When this occurs, for example, the light from the photocell sensor 28 will be able to pass through the cover 20 once again, the sensor electronic circuit 30 will cease the supply of power to the heating element 22.

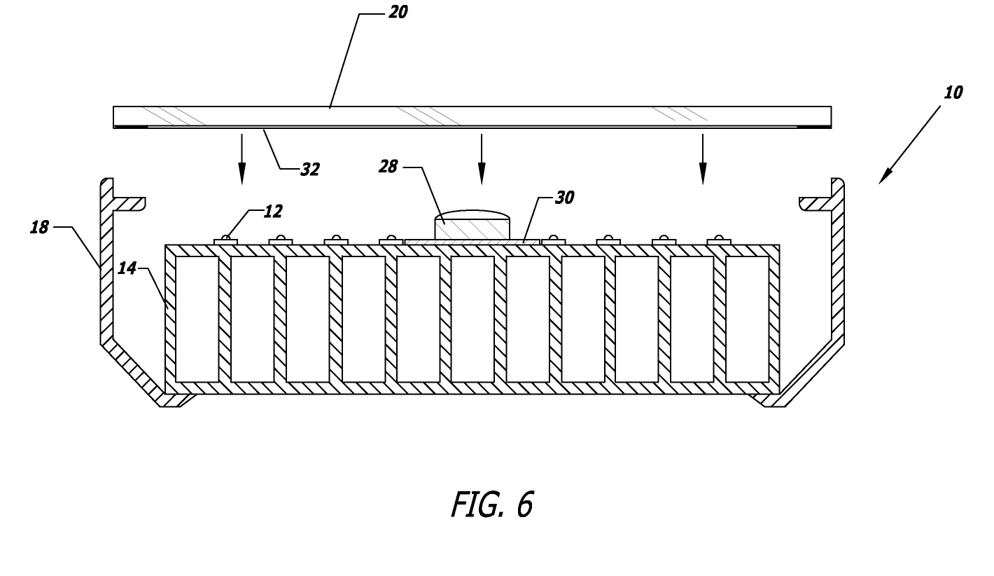

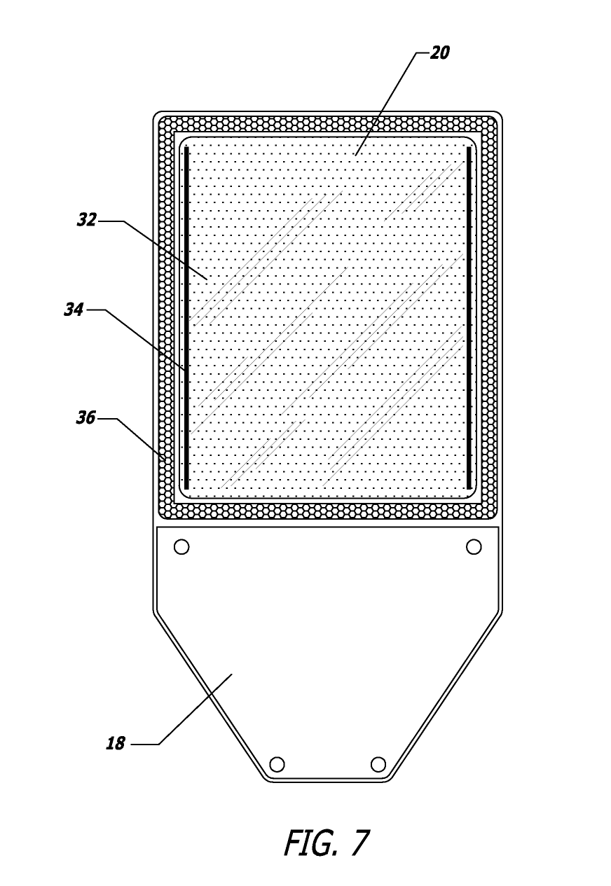

With reference now to FIGS. 6 and 7, a lamp assembly 10 embodying the present invention is shown wherein the thermal heating element 32 comprises a coating disposed on at least a portion of the surface of the cover. This can be, for example, by coating the inner surface of the cover 20 with electrically conductive material, such as tin oxide, and then applying power through two conductive bus bars 34. It will be appreciated that the thin electrically conductive coating 32 may completely or substantially or merely partially cover the inner surface of the cover 20. Alternatively, the coating may be formed in a pattern, such as a grid of thin trace lines, so as to sufficiently heat the cover 20 material and remove the accumulation of condensation, snow and ice therefrom. An area 36, typically the peripheral edge, of the inner surface of the cover 20 may be sanded or have non-conductive adhesive applied thereto to avoid inadvertent supply electricity to the bus bars 34 and/or conductive coating 32.

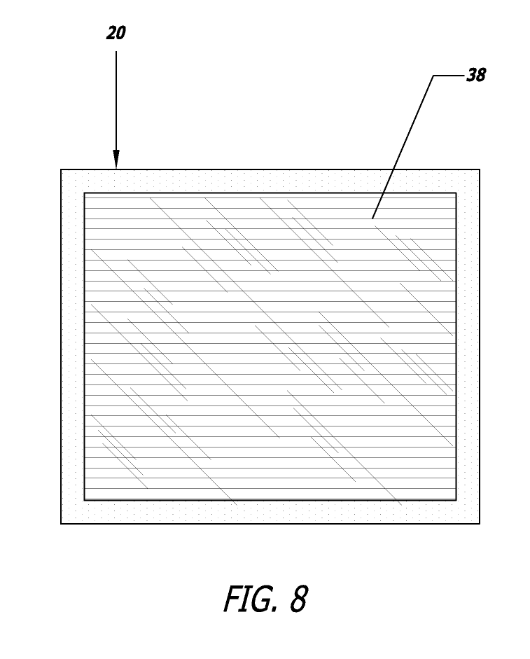

With reference now to FIG. 8, different type of sensors, other than a photocell 28, can be used in accordance with the present invention. For example, conductive electrical traces 38 may be placed on the cover 20, typically on an outer surface thereof, which are sufficiently close to each other that when snow or moisture is collected on the cover 20 a change in electrical connection or capacitance occurs across the conductive thin lines 38, which serves as a signal and acts as a switch to power the heating elements. The accumulated condensation, snow or ice would cause electricity to transfer from one conductive sensor trace line 38 to another, or the presence of the condensation, snow or ice would cause a change in the capacitance between the thin spaced-apart sensor circuit trace lines 38, to cause the activation of the heating elements. Once again, these will be formed on an outer surface of the cover 20, and not an inner surface in order to come directly into contact with the condensation, snow or ice. The sensor circuit traces 38 would be operably connected to circuitry, such as the electronic circuitry 30 illustrated and discussed above, in order to activate the supply of power from the power source 24 to the heating elements.

It is contemplated by the present invention that two different types of sensors could be used, the second as a backup, to ensure proper operation of the lamp assembly 10. Thus, for example, the photocell sensor 28 could be used in conjunction with the conductive sensor thin traces 38 to automatically detect the presence of condensation, snow and ice.

It is also contemplated by the present invention that different types of sensors can be used to detect the accumulation of condensation, snow and ice on the outer surface of the cover 20. The sensor must be able to detect the accumulation of condensation, snow and ice, which might otherwise impede the useful operation of the lamp assembly 10. For example, the sensors could be attached to the cover 20 directly instead of the base 14. In fact, the sensors could be disposed within or without the assembly 10. The sensors could be active or passive.

It is also contemplated by the present invention that different types of heating elements be used to heat the cover 20. The heating elements could be disposed within the housing 18, attached to the housing 18 so as to contact the cover 20 or be attached directly to the cover 20, typically on an inner surface of the cover 20 so as to protect the heating elements, although the invention is not limited to such. For example, the heating elements could comprise conductive traces applied directly to an inner surface of the cover 20. The traces could be screened on the glass in any design or shape to properly heat the glass, similar to that described above with respect to the thin coating heating element. It is also contemplated by the present invention that the circuit traces be placed on thin flexible transparent material which is adhered to or otherwise attached to the cover 20. The bus bars 34 or heating elements, such as in the form of the printed circuit traces, could be sandwiched between the cover and the transparent material.

Although several embodiments have been described in detail for purposes of illustration, various modifications may be made without departing from the scope and spirit of the invention. Accordingly, the invention is not to be limited, except as by the appended claims.

What is claimed is:

1. An outdoor LED lamp, comprising:
a base;
at least one LED chip positioned on the base;
a light transmissive cover disposed over the at least one LED chip; and
a heating element for providing heat to the cover.

2. The LED lamp of claim 1, including a sensor for detecting cover conditions.

3. The LED lamp of claim 2, including an electronic circuit for providing electricity to the heating element to provide heat to the cover when predetermined cover conditions are sensed by the sensor.

4. The LED lamp of claim 3, wherein the predetermined cover conditions comprise water condensation or accumulation of ice or snow on the cover.

5. The LED lamp of claim 1, wherein the heating element comprises a coating disposed on at least a portion of a surface of the cover.

6. The LED lamp of claim 1, wherein the heating element comprises one or more resistance heating elements.

7. The LED lamp of claim 6, wherein the one or more resistance heating elements comprises an electrically conductive wire with sufficient resistance to impart heat to the cover.

8. The LED lamp of claim 6, wherein the one or more resistance heating elements are disposed on or adjacent to a peripheral edge of the cover.

9. The LED lamp of claim 2, wherein the sensor comprises a photosensor.

10. The LED lamp of claim 2, wherein the sensor comprises spaced apart conductive traces disposed on the cover which provide an electrical signal when condensation or ice or snow extends across adjacent conductive traces.

11. An outdoor LED lamp, comprising:
a base;
at least one LED chip positioned on the base;
a light transmissive cover disposed over the at least one LED chip;
a sensor for detecting predetermined cover conditions, including water condensation or accumulation of ice or snow on the cover;
a heating element for providing heat to the cover; and
an electronic circuit for providing electricity to the heating element to provide heat to the cover when the predetermined cover conditions are sensed by the sensor.

12. The LED lamp of claim 11, wherein the heating element comprises a coating disposed on at least a portion of a surface of the cover.

13. The LED lamp of claim 11, wherein the heating element comprises one or more resistance heating elements.

14. The LED lamp of claim 13, wherein the one or more resistance heating elements comprises an electrically conductive wire with sufficient resistance to impart heat to the cover.

15. The LED lamp of claim 13, wherein the one or more resistance heating elements are disposed on or adjacent to a peripheral edge of the cover.

16. The LED lamp of claim 11, wherein the sensor comprises a photosensor.

17. The LED lamp of claim 11, wherein the sensor comprises spaced apart conductive traces disposed on the cover which provide an electrical signal when condensation or ice or snow extends across adjacent conductive traces.
